(19) United States
(12) Patent Application Publication
(10) Pub. No.: US 2017/0211748 A1
(43) Pub. Date: Jul. 27, 2017

(54) LOW TEMPERATURE HELIUM INJECTION

(71) Applicants: Lukas Tobeiner, Breitenfurt (AU); Johannes Hell, Ober-Grafendorf (AU); Markus Stephan, Dombach (AU); Kyle Steiner McKeown, San Francisco, CA (US)

(72) Inventors: Lukas Tobeiner, Breitenfurt (AU); Johannes Hell, Ober-Grafendorf (AU); Markus Stephan, Dombach (AU); Kyle Steiner McKeown, San Francisco, CA (US)

(21) Appl. No.: 15/387,700

(22) Filed: Dec. 22, 2016

Related U.S. Application Data
(60) Provisional application No. 62/286,550, filed on Jan. 25, 2016.

(51) Int. Cl. F17C 5/06

(52) U.S. Cl. CPC F17C 5/06; F17C 2221/017; F17C 2227/0388; F17C 2260/023

(57) ABSTRACT

A system for obtaining helium that avoids boil off losses from the system. A combination of heat exchangers and a compressor are used to deliver helium at a temperature of 30° K and a pressure between 300 bar and 700 bar without significant boil off losses.

### FIELD OF THE INVENTION

The invention relates to providing helium to equipment and processes, wherein the helium is contained in pressurized cylinders that maintain the helium at specific temperatures as needed by the equipment or process.

### BACKGROUND OF INVENTION

Helium is generally stored in a liquid state in relatively large storage tanks. However, when helium in a gaseous state is needed for equipment or processes, the helium must be provided by smaller pressurized cylinders that maintain the helium in a gaseous state, e.g. at relatively high pressure and a temperature that maintains the helium in a gaseous state.

One example of the use of a cylinder of gaseous helium as a source of pressurizing gas for a pressure-fed engine. In such a system, it is desirable to use the helium as the pressurizing agent in order to eliminate the use turbopumps. In operation, the pressurized helium is connected through check valves to high pressure vessels. The pressure from the helium forces the propellants from their tanks so that the propellants can be mixed appropriately to serve as the propellant for the engine.

There are known systems for producing pressurized helium tanks such as those needed for pressure-fed engines, wherein the helium is provided from a storage tank using a pumping system. An existing storage and pumping system is shown in FIG. 1. In this system 100, the helium is stored as liquid helium in a vacuum insulated tank 10 at approximately 0.5 bar pressure. At such a pressure, the liquid helium has a temperature of about 4° K. To be able to store more helium in higher pressure vessels, the temperature needs to be kept as low as possible (30° K or less). In order to achieve this, using the system shown in FIG. 1, the helium is transferred from the tank 10, via a vacuum jacketed line 12, to a liquid helium pump 20. The pump 20, increases the pressure of the liquid helium up to the range of 300 bar to 700 bar. By increasing the pressure, the temperature of the helium is also increased and the helium vaporizes. For example, if the pressure of the helium is increased to about 430 bar, the temperature will be increased to about 40° K, It is very difficult to obtain the necessary 30° K temperature using only the pump 20. Helium that boils off from the pump 20, may be returned to the tank 10, via boil off line 22.

Therefore, a heat exchanger 30, is included in the system 100, to reach the required 30° K temperature at the discharge side of the system 100, for filling helium cylinders through product line 32. The heat exchanger 30, receives liquid helium from the pump 20, via supply line 24. The heat exchanger uses liquid helium from the tank 10, provided through vacuum jacketed helium line 14, as the cooling media. When using a system 100, as described above, there is a considerable (very high) amount of helium that vaporizes, particularly in the heat exchanger 30, that is vented to atmosphere through boil off line 34. This boil off helium can not be used as it is at ambient pressure.

Release of boil off helium is disadvantageous for a number of reasons, not least of which it is a waste of valuable helium. In order to avoid the boil off problem at the heat exchanger, additional equipment would he required, including a recovery compressor that could capture the vaporized helium and compress it to a usable pressure, as well as a storage medium to store the compressed helium from the compressor. Alternatively, the vaporized helium could be re-liquified and returned to the main storage tank. This has the disadvantages of both complicating the system and increasing the cost of the system and the operation thereof. In either recovery system a lot of electric power is needed for either the compressor or liquefier, again adding operation costs to the system.

There remains a need in the art for improvements to systems for providing pressurized cylinders of liquid helium.

### SUMMARY OF THE PRESENT INVENTION

The invention provides improved systems for providing pressurized cylinders of helium that avoids the problem of boil off losses from the system. These advantages are achieved according to the invention by installing a compressor in place of the pump used in known systems. Using a compressor according to the invention allows use of downstream liquid helium as the cooling medium for the heat exchanger at the discharge side of the compressor. Vaporized helium can be returned to the compressor rather than being vented to the atmosphere, thereby reducing helium waste and reducing operating costs. According to the invention it is possible to achieve cylinders of helium at 30° K and 430 bar without significant boil off losses.

### BRIEF DESCRIPTION OF THE DRAWINGS

FIG. 1 is a schematic drawing of a system for delivery of liquid helium as known in the prior art.

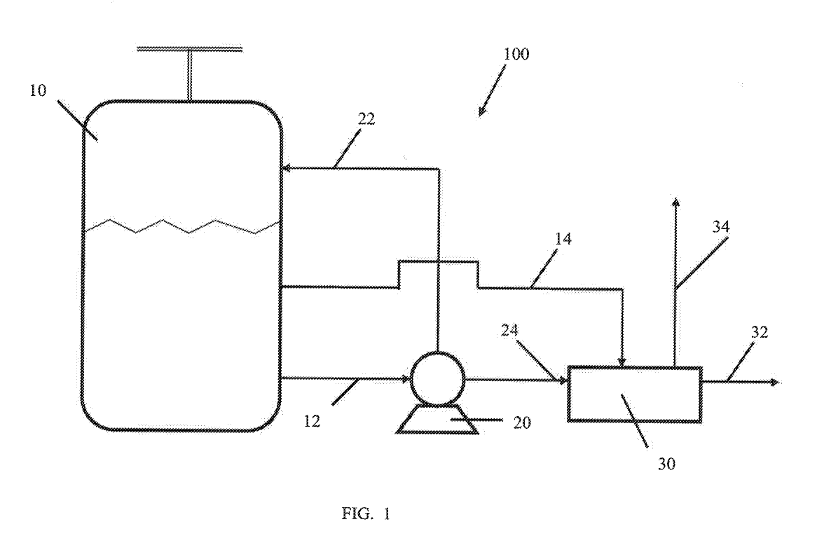

FIG. 2 is a schematic drawing of a system for delivery of liquid helium according to the invention.

FIG. 3 is a schematic drawing showing details of the compressor component of the system according to the invention as shown in FIG. 2.

### DETAILED DESCRIPTION OF THE INVENTION

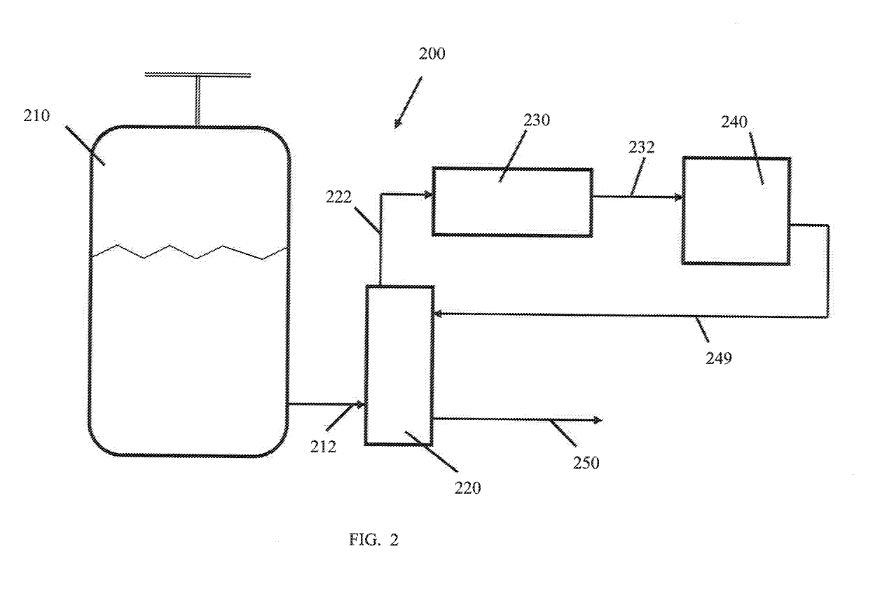

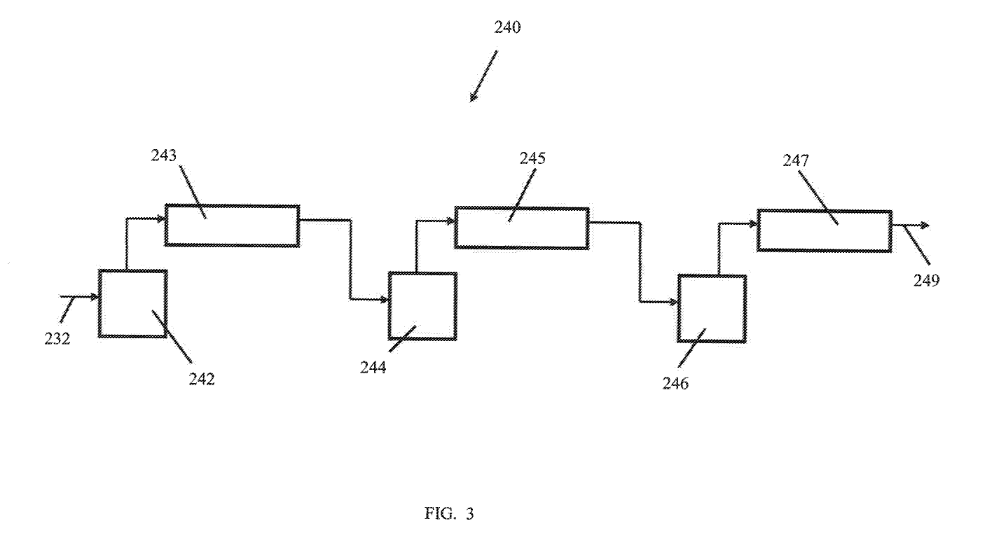

The invention will be described detail with reference to FIG. 2 and FIG. 3.

As shown in FIG. 2, the system 200, includes a liquid helium storage tank 210, that stores liquid helium at about 5° K and a pressure of about 4 bar. As noted, generally the liquid helium is required at 30° K and at a pressure in the range of 300 bar to 700 bar. In order to meet these requirements, the liquid helium from tank 210, must be processed to meet the temperature and pressure requirements.

According to the invention, the system 200, is designed to produce helium at the requisite temperature and pressure. The system 200, includes the tank 210, a first heat exchanger 220, a second heat exchanger 230, and a compressor 240. Liquid helium is transferred from tank 210, to the first heat exchanger 220, via vacuum jacketed line 212. Using the first heat exchanger the temperature of the liquid helium is increased, while the pressure remains the same. The liquid helium is then transported from the first heat exchanger 220, to the second heat exchanger 230, via process line 222. The second heat exchanger 230, uses liquid nitrogen as a cooling medium to decrease the temperature of the liquid helium, again keeping the pressure the same. The liquid helium discharged from the second heat exchanger is then delivered to the compressor 240, via process line 232.

The structure and operation of the compressor 240 will be described with reference to FIG. 3. The compressor 240, is a multistage compressor, a three stage compressor as shown in FIG. 3, having a first stage compression unit 242, a second stage compression unit 244, and a third stage compression unit 246. In addition after each of the compression stages, the compressor 240, includes heat exchanger units, with an optional first heat exchange unit 243, between the first stage compression unit 242, and the second stage compression unit 244, a second heat exchange unit 245, between the second stage compression unit 244, and the third stage compression unit 246, and a an optional third heat exchange unit 247, after the third stage compression unit 246.

The cryogenic (gaseous) helium enters the compressor 240, from the process line 232, and is compressed in the first stage compression unit 242, to increase the pressure, which also increases the temperature. The helium is then delivered to second stage compression unit 244, where it is further compressed to further increase the pressure, which again further increases the temperature. (For this discussion, the first optional heat exchanger unit is not used). After being compressed in the second stage compression unit 244, the helium is then cooled using the second heat exchange unit 245, thereby lowering the temperature but maintaining the pressure. The helium is then further compressed using the third stage compression unit 246, to reach the desired pressure. (For this discussion, the third optional heat exchanger is not used).

The gaseous helium exiting the compressor 240, is now at the required pressure, but is at too high a temperature. Therefore, the helium is delivered from the compressor 240, back to the first heat exchanger 220, in reverse flow direction to the helium coming from the tank 210, via process line 249. The gaseous helium is cooled to the desired 30° K using liquid helium from the tank 210 as the cooling medium.

Upon discharge from the first heat exchanger 220, the helium is now at both the required temperature and pressure to be stored in appropriate cylinders via process line 250.

The table below shows physical parameters of the helium at different points within the system of the invention.

| | Temper- | | | |
|---|---|---|---|---|
| System | ature | Pressure | H (enthalpy) | S (entropy) |
| Point | (° K) | (bar) | (KJ/Kg) | (KJ/Kg-K) |
| exit tank and enter | 5 | 4 | 4.39 | 0.439 |
| 1st HE | | | | |
| exit 1^{st} HE and | 151 | 4 | 790.9 | 21.594 |
| enter 2^{nd} HE | | | | |
| exit 2^{nd} HE and | 93 | 4 | 489.01 | 19.073 |
| enter compressor | | | | |
| exit 1^{st} | 180 | 21.2 | 952 | 19.072 |
| compressor unit | | | | |
| enter 2^{nd} | 180 | 21.2 | 952 | 19.072 |
| compressor unit | | | | |
| exit 2^{nd} compressor | 352.1 | 112.36 | 1870 | 19.072 |
| unit and enter 2^{nd} | | | | |
| HE unit | | | | |
| exit 2^{nd} HE unit | 93 | 112.36 | 516 | 12.096 |
| and enter 3^{rd} | | | | |
| compressor unit | | | | |
| exit 3^{rd} compressor | 178 | 600 | 1177.5 | 12.096 |
| unit and enter 3^{rd} | | | | |
| HE unit | | | | |
| exit 3^{rd} HE unit | 178 | 600 | 112.5 | 12.096 |
| without heat exchange | | | | |
| and enter 1^{st} HE | | | | |
| exit 3^{rd} HE unit | 93 | 600 | 657.89 | 8.5916 |
| with heat exchange | | | | |
| and enter 1^{st} HE | | | | |
| exit 1^{st} HE to | 30 | 600 | 326.6 | 2.71 |
| storage cylinder | | | | |

By using the system according to the invention it is possible to obtain helium at 30° K and a pressure between 300 bar and 700 bar without any significant boil off losses. This provides the advantage that precious helium is not wasted.

In addition, the system of the invention is less complicated than the known systems and can be operated more efficiently at an overall lower cost. This is in part because of the special arrangement of the heat exchanger in the system of the invention that allows for supplying helium to the compressor with the full amount of cold energy that can be used for cooling downstream of the compressor.

While the description above includes heat exchangers after each compression stage, in practice, not all of them may be needed. The invention is intended to cover other arrangements having fewer heat exchangers.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. An apparatus for delivery of helium comprising:
a liquid helium storage tank having an outlet;
a first heat exchanger having a first inlet, a second inlet and an outlet, wherein the first inlet is connected to the outlet of the helium storage tank;
a second heat exchanger having an inlet and an outlet, wherein the inlet is connected to the outlet of the first heat exchanger; and
a compressor having an inlet and an outlet, wherein the inlet is connected to the outlet of the second heat exchanger and the outlet is connected to the second inlet of the first heat exchanger.

2. The apparatus of claim I wherein the compressor comprises;
a first stage compression unit having an inlet and an outlet, wherein the inlet is connected to the outlet of the second heat exchanger;
a second stage compression unit having an inlet and an outlet, wherein the inlet is connected to the outlet of the first stage compression unit;
a first compression stage heat exchanger having an inlet and an outlet, wherein the inlet is connected to the outlet of the second stage compression unit; and
a third stage compression unit having an inlet and an outlet, wherein the inlet is connected to the outlet of the first compression stage heat exchanger and wherein the outlet is connected to the second inlet of the first heat exchanger.

3. The apparatus of claim 2, further comprising a second compression stage heat exchanger having an inlet and an outlet, connected between the first stage compression unit and the second stage compression unit and a third compression stage heat exchanger having an inlet and an outlet, connected between the third stage compression unit and the first heat exchanger,

4. The apparatus of claim 1, further comprising a cylinder filling station connected to the outlet of the first heat exchanger.

5. A method of delivering helium comprising;
storing liquid helium at a starting temperature and a starting pressure in a liquid helium storage tank;
delivering liquid helium from the liquid helium storage tank to a first heat exchanger;
heating the liquid helium to a second temperature while maintaining the starting pressure in the first heat exchanger;
delivering the liquid helium from the first heat exchanger o a second heat exchanger;
cooling the liquid helium to a third temperature while maintaining the starting pressure in the second heat exchanger;
delivering the liquid helium from the second heat exchanger to a compressor;
processing the liquid helium in the compressor to produce gaseous helium at a fourth temperature and a final pressure;
delivering the gaseous helium from the compressor to the first heat exchanger;
cooling the gaseous helium in the first heat exchanger to a final temperature while maintaining the final pressure.

6. The method of claim 5, further comprising delivering the gaseous helium from the first heat exchanger at the final temperature and final pressure to storage cylinders.

7. The method of claim 5, wherein the compressor comprises a first stage compression unit, a second stage compression unit, a first compression stage heat exchanger, and a third stage compression unit; and wherein the step of processing the liquid helium in the compressor comprises:
delivering the liquid helium from second heat exchanger to the first stage compression unit;
compressing the liquid helium in the first stage compression unit to produce gaseous helium at a fifth temperature and a second pressure;
delivering the gaseous helium from the first stage compression unit to the second stage compression unit;
compressing the gaseous helium in the second stage compression unit to a sixth temperature and a third pressure;
delivering the gaseous helium from the second stage compression unit to the first compression stage heat exchanger;
cooling the gaseous helium in the first compression stage heat exchanger to a seventh temperature while maintaining the third pressure;
delivering the gaseous helium from the first compression stage heat exchanger to the third stage compression unit;
compressing the gaseous helium in the third stage compression unit to the fourth temperature and the final pressure; and
delivering the gaseous helium from the third stage compression unit to the first heat exchanger.

8. The method of claim 7, wherein the compressor further includes a second compression stage heat exchanger and a third compression stage heat exchanger, the method further comprising:
delivering the gaseous helium from the first stage compression unit to the second compression stage heat exchanger;
delivering the gaseous helium from the second compression stage heat exchanger to the second stage compression unit;
delivering the gaseous helium from the third stage compression unit to the third compression stage heat exchanger; and
delivering the gaseous helium from the third compression stage heat exchanger to the first heat exchanger.

9. The method of claim 5, wherein the starting temperature is about 5° K and the starting pressure is about 4 bar; wherein the second temperature is about 151° K; wherein the third temperature is about 93° K; wherein the fourth temperature is about 178° K and the final pressure is about 600 bar; and wherein the final temperature is about 30° K.

10. The method of claim 7, wherein the starting temperature is about 5° K and the starting pressure is about 4 bar; wherein the second temperature is about 151° K; wherein the third temperature is about 93° K; wherein the fifth temperature is about 180° K and the second pressure is about 21 bar; wherein the sixth temperature is about 352° K and wherein the third pressure is about 112 bar; wherein the seventh temperature is about 93° K; wherein the fourth temperature is about 178° K and the final pressure is about 600 bar; and wherein the final temperature is about 30° K.
